(19) United States
(12) Patent Application Publication
(10) Pub. No.: US 2005/0025425 A1
(43) Pub. Date: Feb. 3, 2005

(54) Method for manucfacturing an optical device having a cavity

(76) Inventor: Christopher Tuck, Swindon (GB)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/487,478

(22) PCT Filed: Aug. 23, 2002
(86) PCT No.: PCT/GB02/03902

(30) Foreign Application Priority Data
Aug. 23, 2001 (GB) 0120577.2

(51) Int. Cl. G02B 6/26

(52) U.S. Cl. 385/39

(57) ABSTRACT

A method of manufacturing an optical device, by forming a cavity (5) of a desired shape in an optical substrate (3) comprising the steps of irradiating, with radiation from a laser source (1), a mask (2) whose surface is patterned in accordance with the desired shape of the cavity (5); and projecting the radiation transmitted through the mask (2) onto the substrate (3) such that substrate material is ablated from an area thereof exposed to the radiation, thereby forming the required cavity (5) in such a way that at least one sidewall of the cavity has a desired inclination relative to a chosen axis.

The present invention relates to a method for use in manufacturing an optical device.

Some optical devices, such as optical sensors, e.g. Fabry-Perot etalons, are produced by forming cavities in optical substrates.

A Fabry-Perot etalon comprises a cavity between two interfaces which are produced either at the boundary of materials of different refractive indices or by the use of semi-reflective mirrors. Light incident on the Fabry-Perot etalon is partially reflected at each interface of the cavity. The reflected waves interfere as a consequence of the phase change that is induced between them by the length of, and material within, the cavity, and form a fringe pattern when collected at a detector. Demodulation of the said fringe pattern allows precise determination of the characteristics associated with the radiation incident on the Fabry-Perot etalon.

Fabry-Perot etalons are produced commercially using optical fibres and including one of the following methods:

fusion splicing a fibre insert to the coated ends of “lead in” and “lead out” fibres, whereby the fibre insert and the lead in/out fibres can be made of the same, or different, material; or

bonding lead in and lead out fibres, separated by an air-gap, within the bore of a microcapillary; or

fusion splicing a hollow core fibre to adjacent lead in and lead out fibres.

Although the above described methods can be adequately used to manufacture Fabry-Perot etalons, they are non-trivial: they impose the need for a number of components, expensive optical equipment such as fusion splicers and an operator skilled in the technology.

According to an aspect of the present invention, there is provided a method for use in manufacturing an optical device, which method comprises the steps of:

forming a cavity of a desired shape in an optical substrate by irradiating, with radiation from a laser source, a mask whose surface is patterned in accordance with the desired shape of the cavity; and

projecting the radiation transmitted through the mask onto the substrate such that the substrate material is ablated from an area thereof exposed to the radiation, thereby forming the required cavity, in such a way that at least one sidewall of the cavity has a desired inclination relative to a chosen axis.

Preferably, the fluence (defined as the energy density of ablating laser radiation incident per unit cross sectional area on the substrate surface) of the laser radiation projected onto the substrate is controlled so as to produce the desired inclination of the or each side wall.

Preferably, the laser is controlled to emit pulsed radiation at a fluence of 8 J/cm².

Preferably, the laser is controlled to emit pulsed radiation at a fluence greater than 8 J/cm².

Desirably, the focus of the radiation projected onto the substrate is selected such that the desired inclination of the or each sidewall is achieved.

Preferably, the position of the optical substrate relative to the ablating radiation is modulated, by moving the optical substrate up or down relative to the ablating radiation.

Preferably, the radiation that is used to irradiate the mask is subjected to demagnification. Desirably, the demagnification ratio is chosen to ensure that the energy density of the ablating laser radiation is greater in magnitude than the ablation threshold of the substrate material.

The optical substrate may, for example, comprise silica or sapphire, preferably in the form of an optical fibre, but can also be an optical fibre made of plastics material. The optical substrate may also comprise other materials that are suitable for use in optical applications, such as chalcogenides and ceramics.

The cavity formed may be used as a Fabry-Perot etalon or in a Mach Zehnder device, or waveguiding structures such as splitters and couplers, or in similar devices.

Preferably, after forming the cavity, material having selected characteristics is inserted into the cavity. The inserted material may react to the presence of a chemical compound or a change in pH level or a change in temperature or to light in the cavity. Optodes, i.e. electrodes that display sensitivity, and react optically, to particular external perturbation may be produced by inserting a material with appropriate characteristics into a cavity produced by this method.

The laser may be an excimer laser that is controlled to emit radiation of excimer wavelengths, preferably at 157 nm, 193 nm, 248 nm, or wavelengths between 193 nm and 248 nm. Ablation of the optical substrate may also be performed using a deep UV source that is able to produce the desired fluence.

According to a second aspect of the present invention, there is provided an apparatus for manufacturing an optical device, by forming a cavity of the desired shape in an optical substrate, which apparatus comprises a mask whose surface is patterned in accordance with the desired shape of the cavity and projecting means for projecting radiation from a laser source onto a substrate through the said mask, which projecting means are operable in such a way that substrate material is ablated from an area thereof exposed to the radiation, thereby forming the required cavity, in such a way that at least one sidewall of the cavity has a desired inclination relative to a chosen axis.

The projecting means may include a doublet that projects the radiation transmitted through the mask onto the substrate.

The projecting means may also include a mirror that projects the radiation transmitted through the mask onto the doublet.

The substrate is preferably mounted on a micropositioner which allows positioning of the substrate relative to the radiation.

Thus, an embodiment of the present invention can provide an alternative method of forming cavities in optical substrates reliably, reproducibly, cheaply, on a mass scale and without any complicated steps.

Reference will now be made, by way of example, to the accompanying drawings, in which:

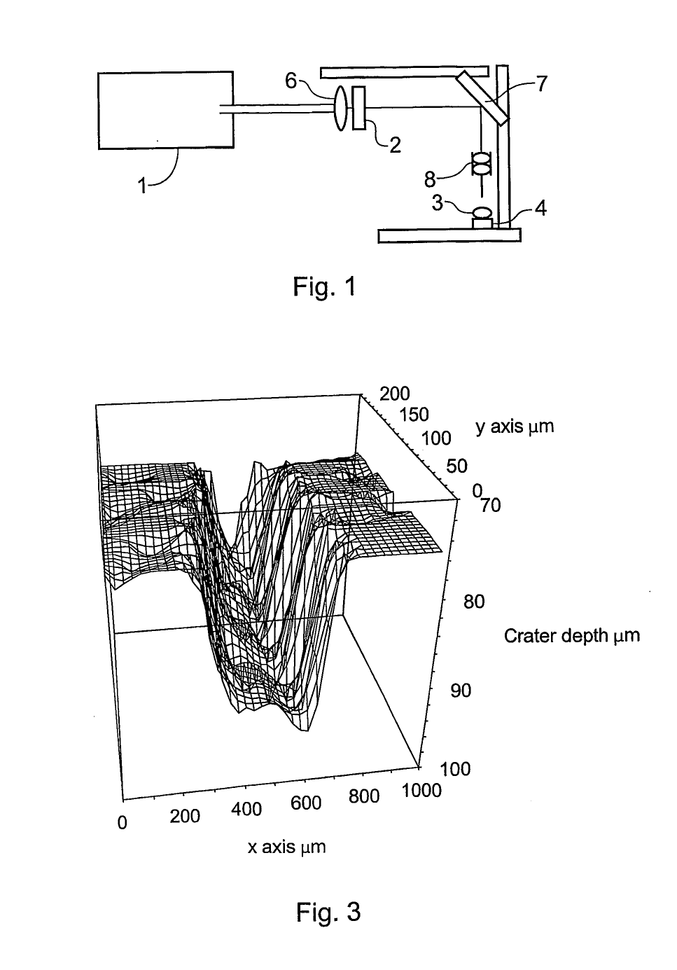

FIG. 1 is a schematic diagram illustrating apparatus embodying the second aspect of the present invention;

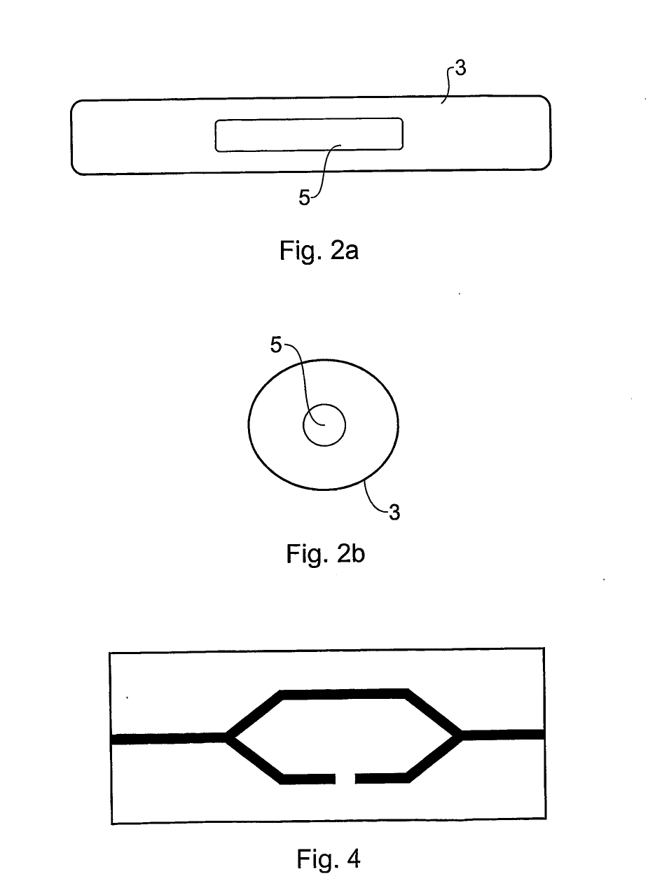

FIG. 2 shows two shapes of cavity that can be formed in an optical substrate using a method embodying the first aspect of the present invention;

FIG. 3 is a graph showing the three dimensional profile of a cavity formed in an optical substrate using a method embodying the first aspect of the present invention;

FIG. 4 is a schematic diagram of a Mach-Zehnder device which may be formed using a method embodying the first aspect of the present invention;

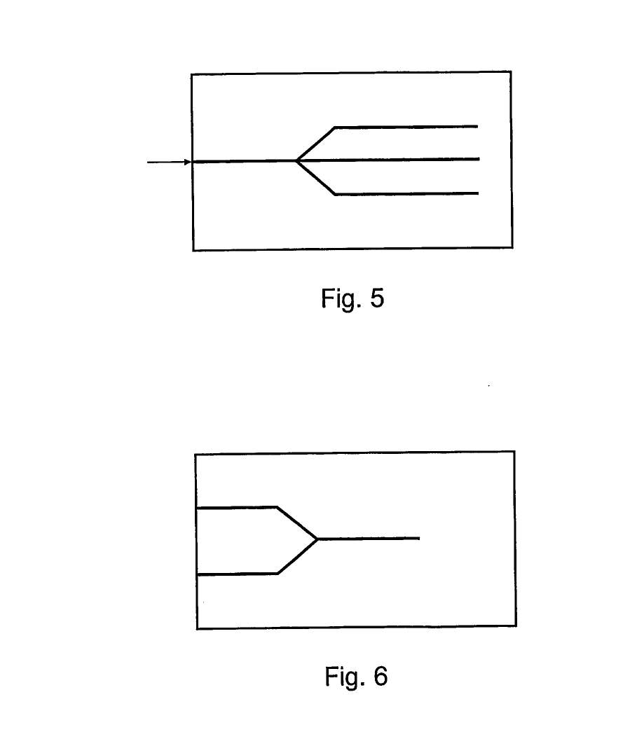

FIG. 5 is a schematic diagram of a splitter which may be formed using a method embodying the first aspect of the present invention; and

FIG. 6 is a schematic diagram of a coupler which may be formed using a method embodying the first aspect of the present invention.

As shown in FIG. 1, apparatus embodying the second aspect of the present invention comprises a laser 1 that is controlled to emit radiation which is used for irradiating a mask 2 whose surface is patterned in accordance with the desired shape of a cavity 5 (see FIG. 2) to be formed in an optical substrate 3 for use in an optical device. The optical substrate 3 is mounted on a micropositioner 4, which facilitates positioning of the optical substrate 3 relative to the ablating laser radiation.

The laser radiation that is used for irradiating the mask 2 is subjected to demagnification by a condenser lens 6.

The laser radiation that is transmitted through the mask 2 is projected onto the optical substrate 3, via projecting means comprising a mirror 7 and a doublet 8, in such a way that substrate material is thereby ablated from an area thereof exposed to the radiation, to form a cavity 5 in such a way that the cavity is of the required depth and that at least one of its sidewalls has a desired inclination relative to a chosen axis.

A cavity can be produced whose adjacent sidewalls are, for example, parallel, or tapered, with respect to each other. This can be achieved by controlling the fluence of the laser radiation projected onto the substrate so as to be at an appropriate level. It can also be achieved by appropriate selection and/or adjustment of the focus of the ablating radiation projected onto the substrate, for example, by selection and/or adjustment of the focussing optics or modulating the position of the optical substrate relative to the ablating radiation by moving the optical substrate up or down relative to the ablating radiation during the ablation process.

In this manner, cavities of any desired shape may be formed in an optical substrate; two examples are shown in FIG. 2. FIG. 2a shows one possible configuration of an ablated cavity formed on the exterior of the fibre parallel to its axis. FIG. 2b shows the fibre with an ablated cavity formed concentrically with the axis of the fibre. Each of the configurations shown allows the direct production of temperature, strain and pressure optodes along with vibration optodes (using a cantilevered beam). FIG. 2b is particularly useful as it allows a sheet of material to be placed over the end of the cavity 5 to act as a diaphragm enabling the measurement of pressure. The three-dimensional profile of a cavity produced in a sapphire disk by use of the present invention is shown in FIG. 3. A surface roughness of significantly less than 5 μm is possible, for example, roughness average (Rₐ) values of 0.451 μm have been measured for pitted silica surfaces produced using the present invention.

The laser 1 is preferably an excimer laser whose power is tunable. It is controlled to emit radiation at excimer wavelengths, preferably at 157 nm, 193 nm, 248 nm or wavelengths between 193 nm and 248 nm, for a time period determined by the rate of ablation of the substrate material concerned, and the desired depth of the cavity to be formed. Alternatively, laser 1 may also be a deep UV laser that is controlled to emit radiation of deep UV wavelengths of the desired fluence.

The ablation rate of the substrate material depends on factors such as the fluence and the surface condition (Rₐ value) of the substrate. For example, Ihlemann et al. (Applied Surface Science, 106, p.282-286, 1996) found that the ablation rate of silica when using 193 nm excimer radiation in the form of 18 ns pulses and at a fluence of 4 J/cm² is approximately 200 nm/pulse and approximately 300 nm/pulse when using 248 nm excimer radiation in the form of 24 ns pulses and at a fluence of 15 J/cm². The ablation rate of sapphire when using 193 nm excimer radiation in the form of 18 ns pulses and at a fluence of 4 J/cm² is approximately 25 nm/pulse and approximately 100 nm/pulse when using 248 nm excimer radiation in the form of 24 ns pulses and at a fluence of 5 J/cm². Their data also showed that the ablation rate of the material is additionally dependent on the pulse width of the ablating laser radiation, which can be adjusted to either increase or decrease the ablation rate of the substrate surface in real time.

In the apparatus embodying the second aspect of the present invention shown in FIG. 1, excimer radiation of the said wavelengths, comprising pulses of approximately 30 ns duration, at a fluence of 8 J/cm² is used for ablation of the optical substrate 3. The ablation procedure can also be performed using excimer radiation of the said wavelengths comprising nanosecond pulses, and another fluence value that should be chosen to exceed the ablation threshold of the optical substrate 3 in magnitude.

The optical substrate 3 preferably comprises silica or sapphire, conveniently in the form of an optical fibre, but can also be an optical fibre made of plastics material.

The ablation threshold values for silica and sapphire, when 193 nm excimer excitation is used, are approximately 4 J/cm² and 2 J/cm², respectively. When 248 nm excimer excitation is used, the ablation threshold values for silica and sapphire are approximately 12 J/cm² and 3 J/cm², respectively.

The mask 2 is produced by photo-etching the surface of a chromium-backed silica plate in accordance with the desired shape of the cavity. Masks of the required kind can be obtained from Central Microstructure facility, Rutherford Appleton Laboratory, University of Oxford, UK, and Compugraphics International Ltd, UK.

The condenser lens 6, which has a focal length of 450 mm, demagnifies the radiation that is used for irradiating the mask 2. The demagnification ratio is chosen to ensure that the energy density of the ablating laser radiation is greater in magnitude than the ablation threshold of the substrate material. The demagnifying action of the said condenser lens 6 determines the power of laser radiation that is used for ablation of the optical substrate 3. For example, 10:1 demagnification reduces the area irradiated by a factor of 100, so that if the energy emitted by the laser 1 is 500 mJ/cm², the optical substrate 3 receives 50 J/cm².

The doublet 8 focuses the radiation transmitted through the mask 2 onto the optical substrate 3.

The mirror 7 focuses the radiation transmitted through the mask 2 onto the doublet 8.

Ablation of the optical substrate 3 using a method embodying the present invention can result in cavities with rough surfaces, particularly when 193 nm, or 248 nm, excimer wavelength radiation is used. The photon energy of light at these wavelengths is not sufficient to break bonds within the material comprising the optical substrate 3 (especially if the material is fused silica). Thus, multi-photon absorption and higher fluence values are required to achieve ablation of the optical substrate 3, which factors serve to roughen the surfaces of the cavities that are consequently produced and cause the inappropriate reflection of light by the surfaces of such cavities. It may be possible to produce cavities with smoother surfaces by using 157 nm excimer wavelength laser radiation in a method embodying the present invention as single photon absorption may be sufficient for ablating the optical substrate 3 at this wavelength value.

In order to minimise the surface roughness of cavities produced using a method embodying the present invention, a further processing step is introduced after such cavity production, in which the substrate is subjected to etching (by using a suitable etchant, for example, hydrofluoric acid) or annealing at a temperature close to the melting point of the material constituting the optical substrate 3, which causes the material to re-flow, and, consequently, to reduce the roughness of the cavity surfaces. Alternatively, reactive-ion etching, or focussed-ion-beam milling, can be used to smooth the surfaces of a cavity that is initially formed using a method embodying the present invention.

After formation of the cavity in the optical substrate 3 by use of the present invention, material of specific characteristics may be inserted into the cavity. For example, material which reacts to a change in temperature or pH level, or which reacts to light or the presence of a chemical compound, may be used. In this way, optodes sensitive to particular external perturbation may be produced by inserting a material with appropriate characteristics into the cavity.

The present invention may also be used for the production of optical devices such as the Mach Zehnder device shown in FIG. 4, and/or waveguiding structures like the splitter shown in FIG. 5 and coupler shown in FIG. 6, on bulk optical substrates. In the case of the Mach-Zehnder device shown in FIG. 4, a cavity of desired shape in an optical substrate such as silica would then be filled with material of higher refractive index.

1-38. cancel

39. A method for use in manufacturing an optical device which method comprises the steps of:
forming a cavity of a desired shape in an optical substrate by irradiating, with radiation from a laser source, a mask whose surface is patterned in accordance with the desired shape of the cavity;
and projecting the radiation transmitted through the mask onto the substrate such that the substrate material is ablated from an area thereof exposed to the radiation, thereby forming the required cavity, in such a way that at least one sidewall of the cavity has a desired inclination relative to a chosen axis.

40. A method as claimed in claim 39, wherein the fluence of the laser radiation projected onto the substrate is controlled so as to produce the desired inclination of the or each side wall.

41. A method as claimed in claim 40, wherein the laser is controlled to emit pulsed radiation at a fluence of 8 J/cm².

42. A method as claimed in claim 40, wherein the laser is controlled to emit pulsed radiation at a fluence greater than 8 J/cm².

43. A method as claimed in claim 39, wherein the focus of the ablating radiation projected onto the substrate is selected and/or adjusted such that the desired inclination of the or each sidewall is achieved.

44. A method as claimed in claim 43, wherein the position of the optical substrate relative to the ablating radiation is modulated, by moving the optical substrate up or down relative to the ablating radiation.

45. A method as claimed in claim 39, wherein the radiation that is used to irradiate the mask subjected to demagnification prior to being projected onto the substrate.

46. A method as claimed in claim 45, wherein the demagnification ratio is chosen to ensure that the energy density of the ablating laser radiation is greater in magnitude than the ablation threshold of the substrate material.

47. A method as claimed in claim 39, wherein the optical substrate is in the form of an optical fibre.

48. A method as claimed in claim 47, wherein the optical fibre is made of plastics material.

49. A method as claimed in claim 39, wherein the optical substrate comprises silica.

50. A method as claimed in claim 39, wherein the optical substrate comprises sapphire.

51. A method as claimed in claim 39, wherein the optical substrate comprises material that is suitable for optical applications.

52. A method as claimed in claim 51, wherein the material is chalcogenide or ceramic.

53. A method as claimed in claim 39, wherein the cavity is formed in a bulk optical substrate and is suitable for use in optical circuits.

54. A method as claimed in claim 39, wherein the cavity formed is suitable for use as a Fabry-Perot etalon.

55. A method as claimed in claim 39, wherein the cavity formed is suitable for use in a Mach Zehnder device.

56. A method as claimed in claim 39, wherein the cavity formed is suitable for use in waveguiding structures.

57. A method as claimed in claim 39, wherein, after forming the cavity, material having selected characteristics is inserted into the cavity to form an optode that is sensitive to external perturbation, the sensitivity of the said optode being determined by the characteristics of the material inserted into the cavity.

58. A method as claimed in claim 57, wherein the inserted material reacts to the presence of a chemical compound.

59. A method as claimed in claim 57, wherein the inserted material reacts to a change in pH level.

60. A method as claimed in claim 57, wherein the inserted material reacts to a change in temperature.

61. A method as claimed in claim 57, wherein the inserted material reacts to light.

62. A method as claimed in claim 39, wherein the laser is an excimer laser that is controlled to emit radiation of excimer wavelength.

63. A method as claimed in claim 39, wherein the laser is controlled to emit radiation of 157 nm wavelength.

64. A method as claimed in claim 39, wherein the laser is controlled to emit radiation of 193 nm wavelength.

65. A method as claimed in claim 39, wherein the laser is controlled to emit radiation of 248 nm wavelength.

66. A method as claimed in claim 39, wherein the laser is controlled to emit pulsed radiation between 193 nm and 248 nm wavelengths.

67. A method as claimed in claim 39, wherein the laser is a deep UV laser that is controlled to emit radiation of deep UV wavelengths.

68. An apparatus for manufacturing an optical device by forming a cavity of a desired shape in an optical substrate, which apparatus comprises a mask whose surface is patterned in accordance with the desired shape of the cavity and means for projecting radiation from a laser source onto a substrate through the mask, the means for projecting operable in such a way that substrate material is ablated from an area thereof exposed to in such a way that at least one sidewall of the cavity has a desired inclination relative to a chosen axis.

69. An apparatus as claimed in claim 68, wherein a condenser lens is used to demagnify the laser radiation that is used to irradiate the mask.

70. An apparatus as claimed in claim 68, wherein the demagnification ratio is chosen to ensure that the energy density of the ablating laser radiation is greater in magnitude than the ablation threshold of the substrate material.

71. An apparatus as claimed in claim 68, wherein the means for projecting includes a doublet that focuses the radiation transmitted through the mask onto the optical substrate.

72. An apparatus as claimed in claim 68, wherein the means for projecting includes a mirror that projects the radiation transmitted through the mask onto the doublet.

73. An apparatus as claimed in claim 68, wherein the substrate is mounted on a micropositioner.

74. An apparatus as claimed in claim 73, wherein the micropositioner allows positioning of the substrate relative to the radiation.
